(19) United States
(12) Patent Application Publication
(10) Pub. No.: US 2008/0127457 A1
(43) Pub. Date: Jun. 5, 2008

(54) Doorstop

(76) Inventors: Jinn-Yi Deng, Changhua Hsien (TW); Sung-Yung Yang, Changhua Hsien (TW); Shwu-Fen Hwang, Changhua Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/633,338

(22) Filed: Dec. 4, 2006

(51) Int. Cl. E05D 7/00

(52) U.S. Cl. 16/402

(57) ABSTRACT

A shoe has a sole, an upper and a counter portion. The upper is securely connected to the sole and has a rear end defined with an opening. The counter portion is pivotally connected to a rear end of the sole to close the opening in the upper. A fastener is mounted on the upper and the pivotal counter portion to connect the pivotal counter portion to the rear end of the upper. Accordingly, a wearer's foot in the shoe can be vented. Also, for a pair of tied shoes with the pivotal counter portions can be put on or taken off without tying or untying the laces. The use of the shoe becomes more versatile and more convenient.

### BACKGROUND OF THE INVENTION

1. Field of the Invention

The present invention relates to a doorstop, and more particularly to doorstop that can be operated with a foot of a user and is convenient in use.

2. Description of Related Art

To hold a door at an open condition, a doorstop is always mounted on a floor or wall. However, to drill holes in the floor or wall is necessary to assembly a traditional doorstop on the floor or wall and this is laborious and inconvenient. A conventional doorstop attached to a door is provided to solve the above problem. The conventional doorstop in accordance with the prior art comprises a base, an arm pivotally attached to the base and a resilient stopper attached to the arm. When the arm is pivoted downward, the stopper will abut against the floor and provide a friction force to the door to keep the door at an open condition. When the arm is pivoted upward and the stopper leaves the position abutting against the floor, the door can be closed freely. However, to pivot the arm relative to the base always needs hands, and this is inconvenient and easily pollutes the user's hands.

To overcome the shortcomings, the present invention tends to provide a doorstop to mitigate or obviate the aforementioned problems.

### SUMMARY OF THE INVENTION

The main objective of the invention is to provide a doorstop that can be operated with a foot of a user and is convenient in use. The doorstop has a base, a pivotal element, a pushed block, a stopper and a positioning device. The base has a bottom plate, a hemispherical cavity and a slot. The hemispherical cavity is defined in the bottom plate. The slot is defined in the bottom plate and communicates with the hemispherical cavity. The pivotal element is V-shaped, is pivotally mounted in the hemispherical cavity in the base and has two arms extending out from the slot in the base. The arms include an upper arm and a lower arm. The pushed block is mounted on the upper arm of the pivotal element. The stopper is made of a resilient material and is detachably attached to the lower arm of the pivotal element. The positioning device is mounted on the base and abuts against to hold the V-shaped pivotal element in position.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a doorstop in accordance with the present invention;

FIG. 2 is an exploded perspective view of the doorstop in FIG. 1;

FIG. 3 is an operational perspective view of the doorstop in FIG. 1 being attached to a door;

FIG. 4 is a side view in partial section of the door with the doorstop in FIG. 3;

FIG. 5 is an operational side view in partial section of the door with the doorstop in FIG. 4 showing that the pivotal element is pivoted to make a stopper abutting against the floor; and

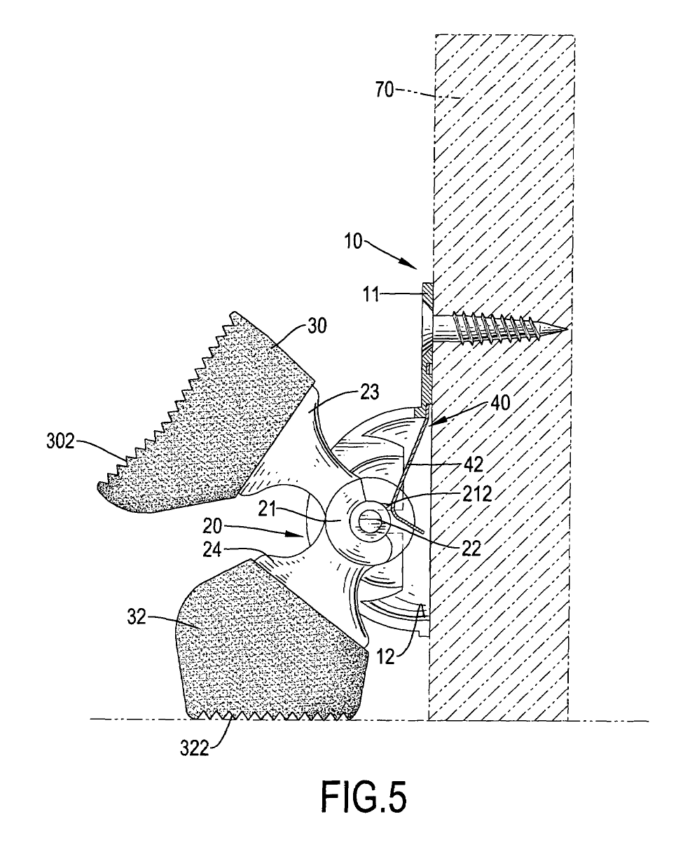

FIG. 6 is an exploded perspective view of a second embodiment of a doorstop in accordance with the present invention.

### DETAILED DESCRIPTION OF PREFERRED EMBODIMENT

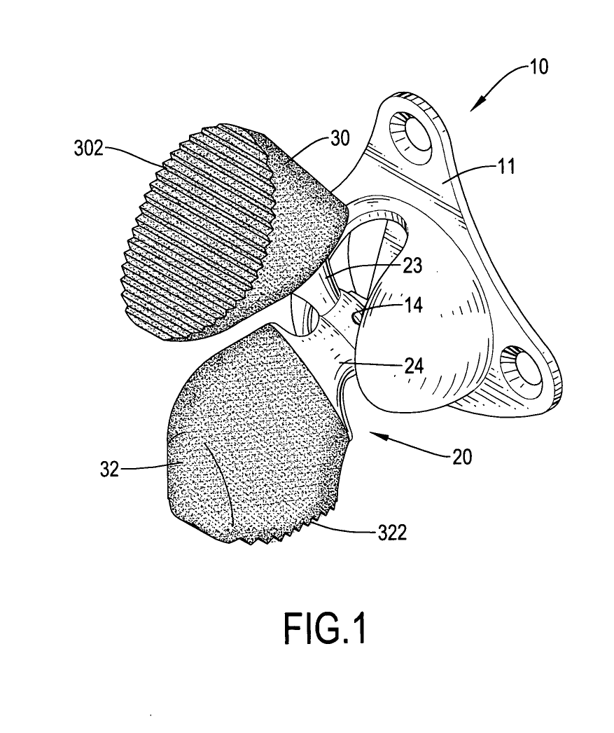

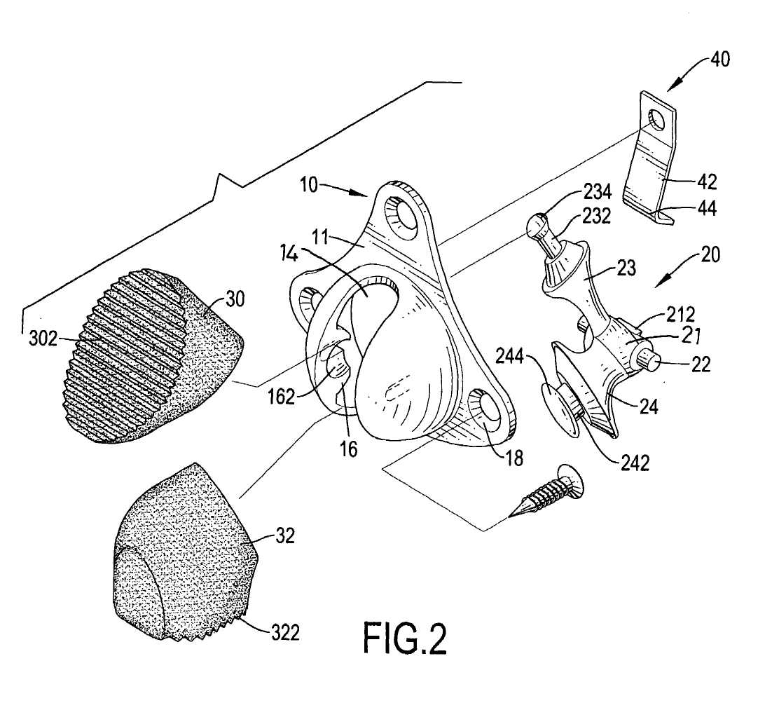

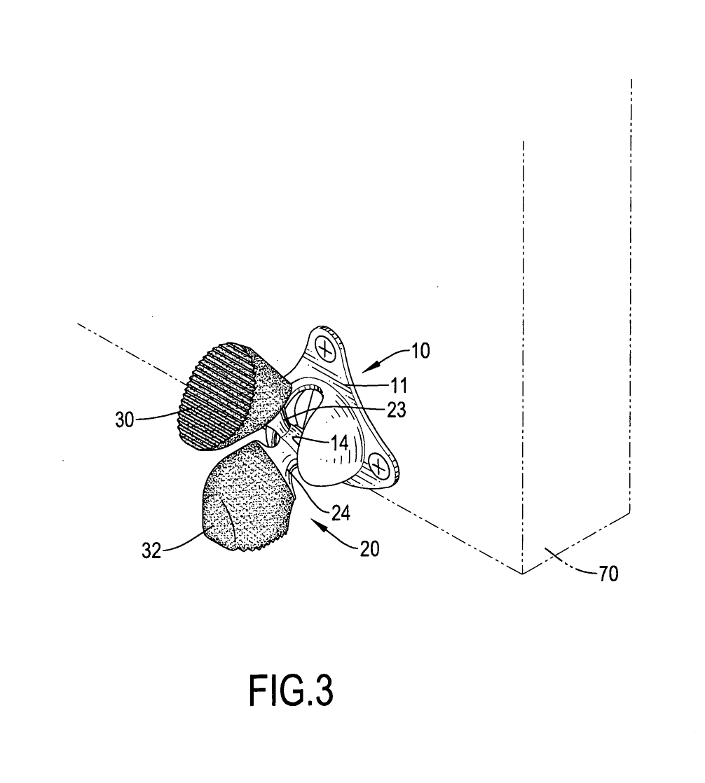

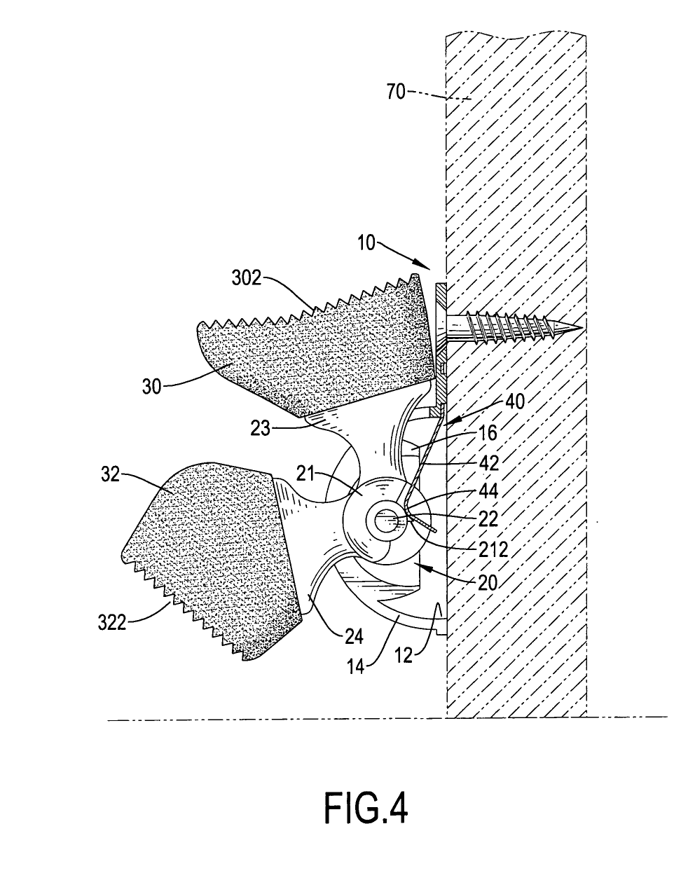

With reference to FIGS. 1 to 4, a doorstop in accordance with the present invention is secured to a door (70) and comprises a base (10), a pivotal element (20), a pushed block (30), a stopper (32) and a positioning device (40). The base (10) comprises a bottom plate (11), a hemispherical cavity (12), a slot (14), two curved flanges (16) and multiple through holes (18). The hemispherical cavity (12) is defined in the bottom plate (11). The slot (14) is defined in the bottom plate (11) and communicates with the hemispherical cavity (12). The curved flanges (16) are parallel with each other and are respectively formed on and extend from two sides of the slot (14). Each curved flange (16) has a pivotal notch (162) defined in the curved flange (16). The through holes (18) are defined through the bottom plate (18) to allow the base (10) to be secured on the door (70) with multiple fasteners.

The pivotal element (20) is V-shaped and is pivotally mounted in the hemispherical cavity (12) in the base (10). The pivotal element (20) comprises a body (21), a pivotal pin (22) and two arms (23,24). The body (21) is pivotally mounted in the cavity (12) between the curved flanges (16). The body (21) of the pivotal element (20) has a positioning rib (212) formed on the body (21). The pivotal pin (22) extends laterally from the body (21) and has two ends rotatably and respectively held in the pivotal notches (162) in the curved flanges (16).

The arms (23,24) mounted on and extend from the body (21) and extend out from the slot (14) in the base (10). The arms (23,24) include an upper arm (23) and a lower arm (24). Each arm (23,24) of the pivotal element (20) has a free end, a shank (232,242) formed on the free end and a head (234,244) formed on the shank (232,242).

In a first embodiment, the arms (23,24) are integrally formed on and extend from the body (21).

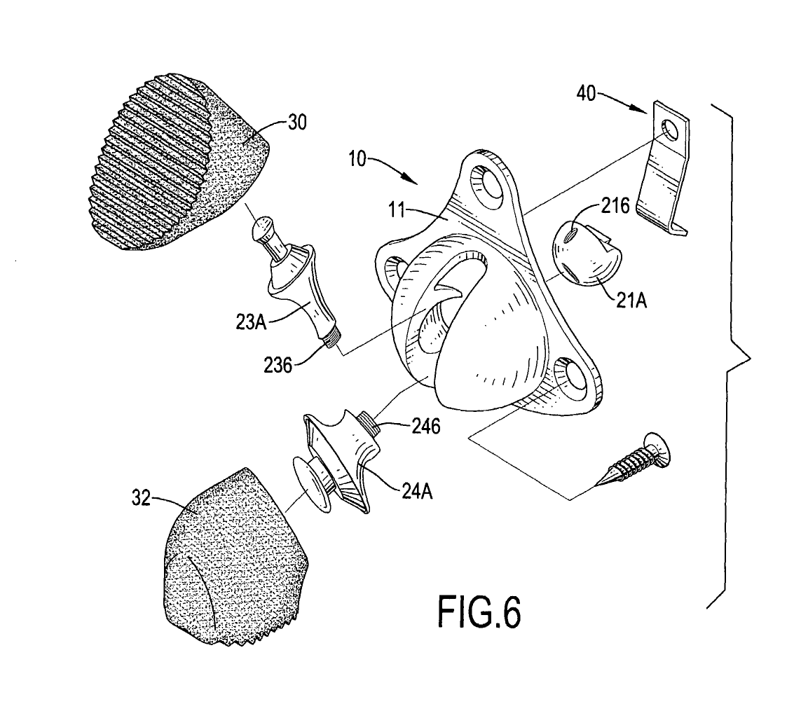

In a second embodiment, with reference to FIG. 6, the arms (23A,24A) are detachably mounted on and extend from the body (21A). In a preferred embodiment, two threaded holes (216) are defined in the body (21A), and each arm (23A,24A) has a threaded end (236,246) screwed into one of the threaded holes (216) in the body (21) to attach the arm (23A,24A) to the body (21A).

The pushed block (30) is made of a resilient material, is detachably mounted on the upper arm (23) and has multiple ridges (302) formed on the top of the pushed block (30).

The stopper (32) is made of a resilient material and is detachably attached to the lower arm (24) of the pivotal element (20). The stopper (32) has multiple ridges (322) formed on the bottom of the stopper (32).

The positioning device (40) is mounted on the base (10) and abuts against pivotal element (20) to hold the V-shaped pivotal element (20) in position. The positioning device (40) comprises a resilient tab (42) attached to the bottom plate (11) of the base (10) and having an engaging portion (44) formed on the resilient tab (42). The engaging portion (44) of the resilient tab (42) is V-shaped and selectively engages the positioning rib (212) on the body (21) of the pivotal element (20) to hold the pivotal element (20) in an unlocked position.

When the doorstop is in an unlocked position, the stopper (32) on the lower arm (24) of the pivotal element (20) is kept away from the floor and the engaging portion (44) on the resilient tab (42) abuts against the positioning rib (212) to keep the pivotal element (20) from rotating downward. Consequently, the user can open or close the door (70) freely.

When the pivotal element (20) is pivoted downward, the stopper (32) is pivoted to a position where abuts against the floor. Accordingly, the door (70) can be kept at an open condition with the friction provided by the stopper (32) and the floor. With the V-shaped pivotal element (20), the pivotal element (20) can be pivoted relative to the base (10) with a foot stepping onto or kicking the pushed block (30) on the upper arm (23). Therefore, the doorstop in accordance with the present invention can be operated with a foot of a user and is convenient in use. The hands of the user can be kept free from operation of the doorstop and will not be polluted.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A doorstop comprising:
a base comprising:
a bottom plate;
a hemispherical cavity defined in the bottom plate; and
a slot defined in the bottom plate and communicating with the hemispherical cavity;
a V-shaped pivotal element pivotally mounted in the hemispherical cavity in the base and having two arms extending out from the slot in the base and including an upper arm and a lower arm;
a pushed block mounted on the upper arm of the pivotal element;
a stopper made of a resilient material and detachably attached to the lower arm of the pivotal element; and
a positioning device mounted on the base and abutting against the V-shaped pivotal element to hold the V-shaped pivotal element in position.

2. The doorstop as claimed in claim 1, wherein the base further has two curved flanges parallel with each other and respectively formed on and extending from two sides of the slot;
each curved flange has a pivotal notch defined in the curved flange; and
the pivotal element comprises
a body pivotally mounted between the curved flanges; and
a pivotal pin extending laterally from the body and having two ends rotatably and respectively held in the pivotal notches in the curved flanges.

3. The doorstop as claimed in claim 2, wherein the arms are integrally formed on and extend from the body.

4. The doorstop as claimed in claim 2, wherein the arms are detachably mounted on and extend from the body.

5. The doorstop as claimed in claim 3, wherein each arm of the pivotal element has a free end, a shank formed on the free end and a head formed on the shank.

6. The doorstop as claimed in claim 4, wherein each arm of the pivotal element has a free end, a shank formed on the free end and a head formed on the shank.

7. The doorstop as claimed in claim 5, wherein the positioning device comprises a resilient tab attached to the bottom plate of the base and having an engaging portion formed on the resilient tab; and
the body of the pivotal element has a positioning rib formed on the body and selectively abutting with the engaging portion on the resilient tab to hold the pivotal element at an unlocked position.

8. The doorstop as claimed in claim 6, wherein the positioning device comprises a resilient tab attached to the bottom plate of the base and having an engaging portion formed on the resilient tab; and
the body of the pivotal element has a positioning rib formed on the body and selectively abutting with the engaging portion on the resilient tab to hold the pivotal element at an unlocked position.

9. The doorstop as claimed in claim 1, wherein each arm of the pivotal element has a free end, a shank formed on the free end and a head formed on the shank.

10. The doorstop as claimed in claim 1, wherein the positioning device comprises a resilient tab attached to the bottom plate of the base and having an engaging portion formed on the resilient tab; and
the body of the pivotal element has a positioning rib formed on the body and selectively abutting with the engaging portion on the resilient tab to hold the pivotal element at an unlocked position.
